(19) United States
(12) Patent Application Publication
(10) Pub. No.: US 2013/0067820 A1
(43) Pub. Date: Mar. 21, 2013

(54) WEATHER SEAL RETAINER APPARATUS

(71) Applicant: Sherman Jett, Marietta, GA (US)

(72) Inventor: Sherman Jett, Marietta, GA (US)

(21) Appl. No.: 13/236,832

(22) Filed: Sep. 20, 2011

(51) Int. Cl. E06B 7/23; E06B 7/16

(52) U.S. Cl. 49/489.1; 49/490.1

(57) ABSTRACT

A durable weather sealing apparatus having a retaining member that comprises a U-shaped attachment cavity within the retaining member for receiving a seal insert that attaches frictionally and/or mechanically to the retaining member. The seal insert is comprised of a flexible and pliable material that has an attachment portion contiguous with a sealing portion. The attachment portion comprises an upper surface having one or more barbs for engagement with the groves of the U-shaped attachment cavity. Once the attachment portion is inserted into the retaining member the barbs lock against the groves of the U-shaped attachment cavity, thereby, locking the seal insert in place. The sealing portion of the seal insert protrudes from the retaining member such that the sealing portion can compresses upon contact with a flat surface to form a seal.

### BACKGROUND OF THE INVENTION

1. Field of the Technology

The present invention relates to exterior weather seals, specifically a door and/or window frame weather sealing apparatus.

2. Background

A weather seal is a material or device used to seal the openings, gaps or cracks of operable door and window units to prevent water and air penetration. Weather seals are typically placed around the doors and windows of buildings to aid in controlling the building's interior climate. Doors and windows are necessary in buildings to allow passage between the inside and outside, and between internal rooms. Doors and windows also used to admit ventilation and light. Furthermore, doors and windows may be used to control the physical atmosphere within a space by enclosing it, excluding air drafts, so that interiors may be more effectively heated or cooled. Doors and windows are also used to enclose areas of a building for acoustic and aesthetic purposes, keeping out sounds as well as, keeping formal and utility areas separate. Placing weather seals around the frame of door and window units aid in preventing air drafts, water and sound penetration.

The weather seals around door and window units typically become weathered and damaged over time. Therefore, weather seals around door frames continue to need constant maintenance and repair. This results in continued expense and hassle for building owners. A common type of repair is to replace the door seals as they become damaged and/or pulled from the frame. Typical door seals consists of rubber or some similar material that is secured to the wall or frame of the door or window. Over time these seals wear out due to temperature extremes and normal every day use. Many current designs feature weather seals that are designed to be easily installed and thus, easily removed by simply pulling the weather seals from the frame of the door or window. Overtime these weather seals do not have a long useful life because, pets, children, etc. can easily remove the weather seals by simply tugging at them. What is needed is a durable weather seal that is easy to install, but that is not easily removable from the door or window frame.

### SUMMARY

The present invention has been developed in response to the present state of the art, and in particular, in response to the problems and needs in the art that have not yet been fully solved by currently available door and window weather sealing devices. Accordingly, embodiments of the present invention provide a durable, long lasting door and window frame weather sealing device.

In an embodiment, a weather sealing device is provided including a retainer apparatus having an elongated section for attachment to a frame or building. The retainer apparatus has a U-shaped attachment cavity with an inner upper portion, an inner lower portion and a inner back stop. The inner upper portion contains one or more rows of groves for engaging a seal insert that is frictionally and/or mechanically attachable to the retainer apparatus. The seal insert comprises a flexible and pliable material having an attachment portion contiguous with a sealing portion. The attachment portion has an oblong shape for insertion into the U-shaped attachment cavity of the retainer apparatus. The attachment portion further comprises an upper surface having one or more barbs for frictional and/or mechanical engagement with the groves of the U-shaped attachment cavity. The attachment portion further comprises a lower surface having one or more barbs for frictional and/or mechanical attachment to the U-shaped attachment cavity. The sealing portion is continuous with the attachment portion such that, the sealing portion protrudes from the attachment cavity so that it is allowed to compress upon contact with a surface to form a seal.

In one embodiment, a durable weather sealing apparatus including a retaining member having a cross-section that is roughly h-shaped. This retaining apparatus resembles an “h” laid on its elongated slide, wherein, the lower surface comprises the elongated portion of the h-shaped retaining member. An upper surface comprises the shorter portion of the h-shaped retaining member. Finally a back-stop portion comprises a middle portion of the h-shaped retaining member. The combination of the lower surface, upper surface and back-stop portions form a U-shaped attachment cavity within the retaining member for receiving a seal insert that is frictionally and/or mechanically attachable to the retaining member. The seal insert is comprised of a flexible and pliable material that has an attachment portion contiguous with a sealing portion. The attachment portion has an oblong shape for insertion into the U-shaped attachment cavity of the retaining member. The attachment portion further comprises an upper surface having one or more barbs for frictional and/or mechanical attachment to the U-shaped attachment cavity. The attachment portion further comprising a lower surface that also has one or more barbs for frictional and/or mechanical attachment to the U-shaped attachment cavity. Once the attachment portion is attached to the retaining member, the sealing portion is continuous with the attachment portion, wherein the sealing portion compresses upon contact with a flat surface to form a seal.

In another embodiment, a retaining member for mounting a weather seal around an opening comprises a cross-section that is roughly h-shaped. This retaining member resembles an “h” laid on its elongated slide, wherein, a lower surface comprises an elongated portion of the h-shaped retaining member, an upper surface comprises a shorter portion of the h-shaped retaining member, and back-stop portion comprises a middle portion of the h-shaped retaining member. The lower surface, upper surface and back-stop portions form a U-shaped attachment cavity within the retaining member for receiving a seal insert that is frictionally and/or mechanically attaches to it.

In a further embodiment, the inner upper portion of the U-shaped attachment cavity comprises one or more rows of groves for frictional and/or mechanical engagement with barbs of a seal insert. Also, an inner lower portion of the U-shaped attachment cavity may also comprise one or more rows of groves for frictional and/or mechanical engagement with barbs of a seal insert.

In another embodiment, the seal insert apparatus comprises a flexible and pliable material having an attachment portion contiguous with a sealing portion. The attachment portion having an oblong shape for insertion into an attachment cavity of a retaining apparatus. The attachment portion further comprises an upper surface having one or more barbs for frictional and/or mechanical engagement with the retaining apparatus. The attachment portion further comprises a lower surface having one or more barbs for frictional and/or mechanical engagement with to the retaining apparatus. The sealing portion being continuous with the attachment portion, wherein the sealing portion compresses upon contact with a flat surface to form a seal.

In a further embodiment, the seal insert is comprised of a flexible and pliable material such as rubber, plastic and/or metal. The barbs may be positioned at an acute, right, obtuse and/or a reflex angle with respect to the attachment portion. The barbs may be comprised of a rigid material such as rubber, plastic or metal.

Reference throughout this specification to features, advantages, or similar language does not imply that all of the features and advantages may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may but, do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will be come more fully apparent from the following description and appended claims or may be learned by the practice of the invention as set forth hereinafter.

### BRIEF DESCRIPTION OF THE DRAWINGS

FIG. 1 is a cross-sectional view of a retaining member, according to an embodiment of the invention;

FIG. 2 is a cross-sectional view of a seal insert, according to an embodiment of the invention;

FIG. 3 is a cross-sectional view of a combination of a retaining member and a seal insert, according to an embodiment of the invention;

FIG. 4 is a cross-sectional view of a combination of a retaining member and a seal insert with the seal insert compressed against flat surface, according to an embodiment of the invention;

FIG. 5 is a view of a comb seal insert, according to an embodiment of the invention; and

FIG. 6 is a cross-sectional view of a combination of a retaining member and a seal insert, according to an embodiment of the invention.

### DETAILED DESCRIPTION OF EXEMPLARY EMBODIMENTS

For purposes of promoting an understanding of the principle of the invention, reference will now be made to the exemplary embodiments illustrated in the drawing(s), and specific language will be used to describe the same. It will never the less be understood that no limitation of the scope of the invention is thereby intended. Any alterations and further modification of the inventive features illustrated herein, and any additional application of the principles of the invention as illustrated herein, which would occur to one skilled in the relevant art and having a possession of this disclosure, are to be considered within the scope of the invention.

A cross section of view of the retaining member is indicated in FIG. 1. The retaining member 100 is substantially “h” shaped and laid on its elongated side such that an attachment cavity 103 is formed for receiving an seal insert. The upper surface of the attachment cavity 103 comprises one or more rows of groves 105 for frictional attachment to a seal insert. In another embodiment, one or more groves may be placed along the lower surface of the attachment cavity 103. Along the bottom surface of the retaining member 100 can be found one or more expansion groves 108 for engagement with a flat surface.

Furthermore, along a rear portion of retaining member 100 is an attachment portion 110. The attachment portion contains one or more attachment holes 117 for attaching a length of the retaining member 100 to a flat surface around a door and/or window. The attachment holes 117 may contain a nail, screw, or other attachment means 115 to securely attach the retaining member 100 to a flat surface.

In a typical embodiment the retaining member 100 a rigid metal strip. In another embodiment, the retaining member 100 is made of a rigid plastic, fiberglass or wood material. In either embodiment the retaining member 100 is produced in elongated portions which can be cut and shaped to fit the dimensions of a door, window or other opening.

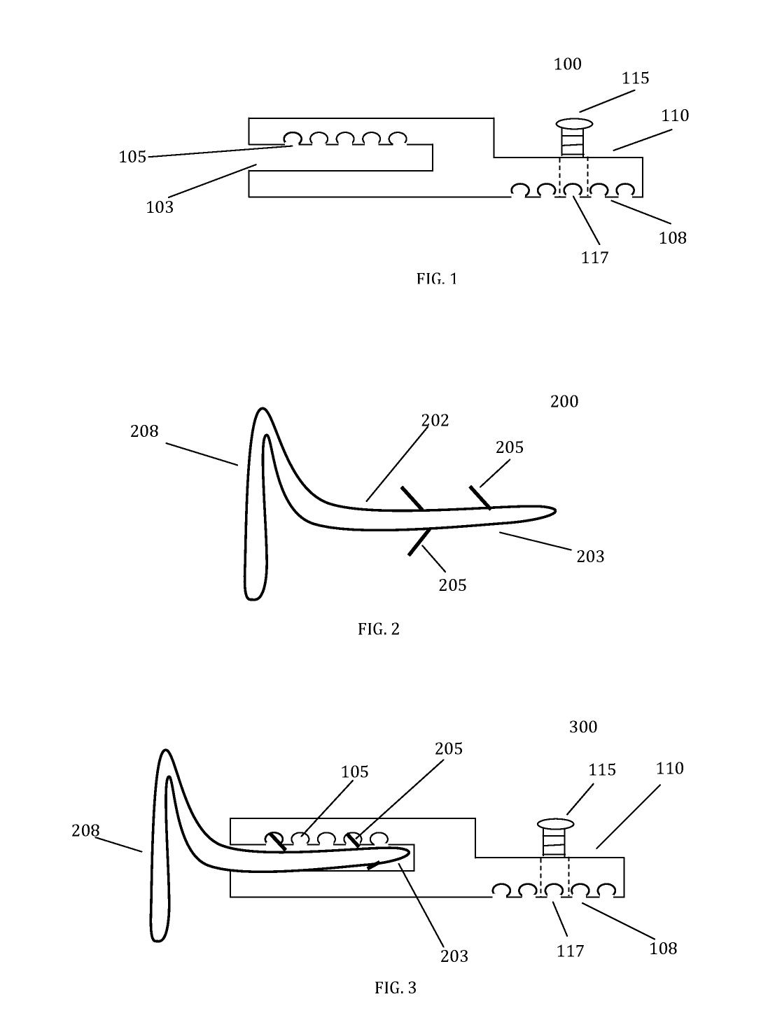

The seal insert 200 is shown in FIG. 2 and having a substantially 7-shaped cross section comprising an attachment portion 202 and a seal portion 208. The attachment portion 202 further comprises an upper surface having one or more barbs 205. These barbs 205 may also be found along a lower surface 203 of the attachment portion 202. At the other end of the seal insert 200 is a seal portion 208. The seal portion 208 is designed to collapse and compress once it comes in contact against a flat surface.

The barbs 205 along the attachment portion 202 and designed to frictional/mechanically engage groves 105 in the insertion cavity 103 of the retaining member 100. The seal insert 200 is made of a flexible and pliable material such as plastic, foam or rubber. The seal insert 200 collapses as it is inserted into the attachment cavity 103. Once fully inserted, the material of the seal insert 200 expands to frictional/mechanically engage the interior of the seal cavity 103, such that the barbs 205 abut groves 105, thereby locking the seal insert 208 into the retaining member 100.

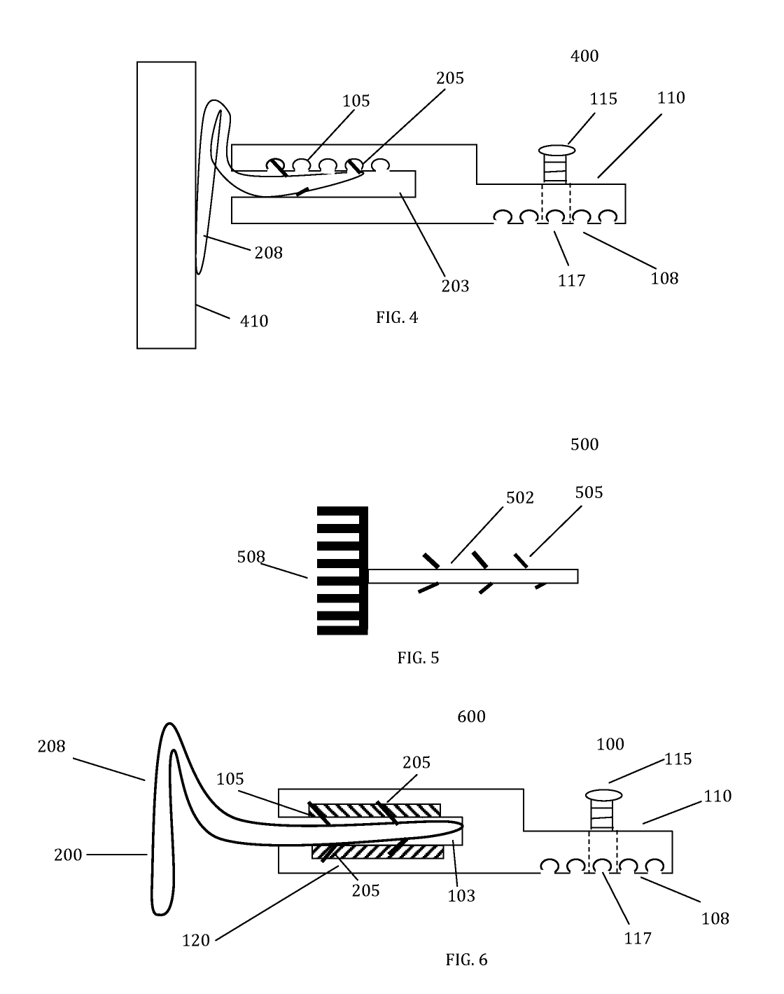

The combination 300 of the seal insert 200 and the retaining member 100 are illustrated in FIG. 3. Once the seal insert 200 is fully inserted into the attachment cavity 103, the barbs 205 expand to frictional/mechanically engage groves 105. Once barbs 205 are locked against groves 105, the seal insert 200 becomes extremely difficult to separate from the retaining member 100. Therefore the weather sealing apparatus 300 becomes permanently attached to frame of the door or window. The remaining seal portion 208 of the seal insert 200 remains around the frame of the door or window. Once the door or window is closed, the flat surface 410 of the door or window presses against the seal portion 208 as illustrated in FIG. 4. The seal portion 208 is designed to collapse against the pressure of the flat surface 410 of a closed door or window, thereby creating an impenetrable seal that prevents air, water, insects, etc. from penetrating the barrier. Furthermore, since the barbs 205 are mechanically locked against groves 105, the seal insert 200 becomes extremely difficult to pull away from the retaining member 100 and thus, frame of the door.

In a typical embodiment, the retaining member 100 would be mounted on both sides and an upper portion of the door frame. Along the bottom of the door, the retaining member 100 may be mounted directly to the bottom of the door. Similarly the retaining member 100 may be mounted around a window or other opening.

FIG. 5 illustrates the seal portion 508 of the seal insert 502 may also comprise a substantially comb or broom shape in another embodiment. The teeth of the comb or broom seal portion may be made of rubber, foam, plastic, bamboo or another flexible material. Seal inserts 502 of this type may be useful for placement onto moving objects, such as the bottom of a door. This design provides a weather seal that is more durable and can withstand the motion of being dragged against a rough surface frequently. The design of the seal portion 508 of the seal insert 502 may comprises other shapes as is needed to adapt to needs of a consumer.

Although groves 105, are illustrated as indentations having a substantially “half-moon” shape, groves 105 may comprise other shapes such as an open square, rectangle, triangle, “T,” or other shape. Similarly, although the barbs 205 are shown has linear protrusions, barbs 205 may also comprise other shapes such as a “half-moon,” square, rectangle, triangle, “T,” or other shape. In still another embodiment, the barbs have complimentary shapes with the groves 105, such that barbs 205 can mechanically, frictionally, or slideably engage the groves 105, such that their complimentary shape locks the barbs 205 in place.

In still another embodiment, barbs 205 are adhesively sealed to groves 105 such that the seal insert 200 becomes locked into the retainer apparatus 100. In another embodiment, the barbs 205 are heat-sealed to groves 105 such that barbs 205 become permanently attached to groves 105.

In still another embodiment, as illustrated in FIG. 6, groves 105 along the upper surface may consist of angled groves slots. Next, along the lower surface, complimentary groves 120, being angled in 180 degrees (opposite) relative to the upper surface groves 105. Similarly, seal insert 200 contains barbs 205 designed to frictionally and mechanically engage groves 105 and 120 along the upper and lower surface of the seal insert cavity 103. The barbs 205 being placed on an upper and lower surface of seal insert 200. Wherein, the barbs 205 along the upper surface of the seal insert 200 are mounted 180 degrees relative to barbs 205 along the lower surface of the seal insert 200, such that the barbs can frictionally and mechanically engage groves 105 and 120 respectively.

In an exemplary embodiment, the seal insert 200 is made of rubber, foam, or plastic. However, the seal insert 200 could also be made of other flexible and pliable materials such metal. Further in an exemplary embodiment, barbs 205 may be made of a rigid plastic. However, the barbs 205 may be also me be made of other flexible, yet rigid materials such as metal. Similarly, in an exemplary embodiment the retaining member 100 is made of a rigid yet malleable metal material. However, the retaining member may also be made of a rigid plastic, fiberglass, wood, or other materials.

Furthermore the seal insert 200 is illustrated as having a substantially 7-shape. However the seal portion 208 may comprise other shapes. Similarly the retaining portion 100 has a substantially h-shape. However the retaining portion 100 may also take on other shapes, although the insertion cavity 103 is required.

Thus, while the present invention has been fully described above with particularity and detail in connection with what is presently deemed to be the most practical and preferred embodiment of the invention, it will be apparent to those of ordinary skill in the art that numerous modifications, including but not limited to, variations in size, materials, shape, form, and function and manner of operation, assembly and use may be made without departing from the principles and concepts of the invention as set forth in the claims. Further, it is contemplated that an embodiment may be limited to consist of, or to consist essentially of one or more of the features, functions, structures, methods, described herein.

What is claimed is:

1. A retainer apparatus for mounting a weather seal around an opening comprising:
an elongated section for attachment to a frame or building; and
said retainer apparatus having a U-shaped attachment cavity having an inner upper portion, an inner lower portion and a inner back stop; wherein
said inner upper portion containing one or more rows of groves for engaging a seal insert that is frictionally or mechanically attachable to said retainer apparatus such that said groves lock said seal insert into said retainer apparatus.

2. The retainer apparatus of claim 1, further comprising: a cross-section roughly h-shaped having a lower surface comprising an elongated portion of the h-shaped cross-section for attachment to said frame or building; an upper surface comprises a shorter portion of the h-shaped cross-section, and back-stop portion comprises a middle portion of the h-shaped cross-section; and wherein
said lower surface, upper surface and back-stop portions form said U-shaped attachment cavity within the retainer apparatus for receiving said seal insert.

3. The retainer apparatus of claim 1, wherein said inner lower portion of said U-shaped attachment cavity comprises one or more rows of groves for frictional and/or mechanical attachment to said seal insert.

4. The retainer apparatus of claim 1, wherein said lower surface comprises one or more rows of expansion groves for attachment to said frame or building.

5. The retainer apparatus of claim 1, wherein said lower surface comprises one or more attachment points for attachment to said frame or building.

6. A seal insert apparatus comprising:
a flexible and pliable material having an attachment portion contiguous with a sealing portion;
said attachment portion having an oblong shape for insertion into an attachment cavity of a retaining apparatus;
said attachment portion further comprising an upper surface having one or more barbs for frictional and/or mechanical attachment to said retaining apparatus;
said attachment portion further comprising a lower surface having one or more barbs for frictional and/or mechanical attachment to said retaining apparatus; and wherein
said sealing portion being continuous with said attachment portion, wherein said sealing portion protrudes from said attachment cavity such that the sealing portion is allowed to compress upon contact with a surface to form a seal.

7. The seal insert apparatus of claim 6, wherein said flexible and pliable material is comprised of rubber and/or plastic.

8. The seal insert apparatus of claim 6, wherein said flexible and pliable material is comprised of metal.

9. The seal insert apparatus of claim 6, wherein said barbs are positioned at an acute, right, obtuse and/or reflex angle with respect to said attachment portion.

10. The seal insert apparatus of claim 6, wherein said barbs comprise a rigid material.

11. The seal insert apparatus of claim 6, wherein said barbs are comprised of rubber, plastic or metal.

12. A weather sealing apparatus comprising:
a retainer apparatus having an elongated section for attachment to a frame or building;
said retainer apparatus having a U-shaped attachment cavity having an inner upper portion, an inner lower portion and a inner back stop; wherein
said inner upper portion containing one or more rows of groves for engaging a seal insert that is frictionally and/or mechanically attachable to said retainer apparatus;
said seal insert comprising a flexible and pliable material having an attachment portion contiguous with a sealing portion;
said attachment portion having an oblong shape for insertion into said U-shaped attachment cavity of said retainer apparatus;
said attachment portion further comprising an upper surface having one or more barbs for frictional and/or mechanical engagement with said groves of said U-shaped attachment cavity;
said attachment portion further comprising a lower surface having one or more barbs for frictional and/or mechanical attachment to said U-shaped attachment cavity; and
said sealing portion being continuous with said attachment portion, wherein said sealing portion protrudes from said attachment cavity such that it is allowed to compresses upon contact with a surface to form a seal.

13. The weather sealing apparatus of claim 12, wherein said retainer apparatus comprises: a cross-section roughly h-shaped having a lower surface comprising an elongated portion of the h-shaped cross-section for attachment to said frame or building, an upper surface comprises a shorter portion of the h-shaped cross-section, and back-stop portion comprises a middle portion of the h-shaped cross-section; and wherein
said lower surface, upper surface and back-stop portions form said U-shaped attachment cavity within the retainer apparatus for receiving said seal insert that is frictionally and/or mechanically attachable to said U-shaped attachment cavity.

14. The weather sealing apparatus of claim 12, wherein an inner lower portion of said U-shaped attachment cavity comprises one or more rows of groves for frictional and/or mechanical attachment to said seal insert.

15. The weather sealing apparatus of claim 12, wherein said lower surface comprises one or more rows of expansion groves for attachment to a building.

16. The weather sealing apparatus of claim 12, wherein said lower surface comprises one or more attachment points for attachment to a building and/or frame.

17. The weather sealing apparatus of claim 12, wherein said flexible and pliable material is comprised rubber and/or plastic.

18. The weather sealing apparatus of claim 12, wherein said flexible and pliable material is comprised of metal.

19. The weather sealing apparatus of claim 12, wherein said barbs are positioned at an acute, right, obtuse and/or reflex angle with respect to said attachment portion.

20. The weather sealing apparatus of claim 12, wherein said barbs are comprised of rubber, plastic or metal.
